(19) United States
(12) Patent Application Publication
(10) Pub. No.: US 2001/0032878 A1
(43) Pub. Date: Oct. 25, 2001

(54) Method and system for making anonymous electronic payments on the world wide web

(76) Inventors: Yiannis S. Tsiounis, New York, NY (US); Charles S. Doherty, Freeport, NY (US); Benjamin Reddy, New York, NY (US); Eilliott Jason Richelson, New York, NY (US)

Correspondence Address: Finnegan, Henderson, Farabow, Garrett & Dunner, L.L.P., 1300 I Street, N.W., Washington, DC, 20005-3315, US

(21) Appl. No.: 09/780,029

(22) Filed: Feb. 9, 2001

Related U.S. Application Data
(60) Provisional application No. 60/181,224, filed on Feb. 9, 2000.
(60) Provisional application No. 60/181,225, filed on Feb. 9, 2000.

(51) Int. Cl. G06F 17/60

(52) U.S. Cl. 235/379

(57) ABSTRACT

Methods and systems consistent with the present invention provide a simple and easy-to-use system to make electronic payments on the Web. Specifically, methods and systems consistent with the present invention provide anonymity, security and accountability. To do so, pre-paid stored value card (“cash card”) including a card identification number for a predetermined amount of money may be purchased at a point of sale. To ensure security, Personal Security Codes are established for a user at a server. To use the cash cards, a user may visit a Web merchant, select an item to purchase, and enter the card identification number and the Personal Security Code to transmit for confirmation to the server. The server subtracts the cost of the item from the predetermined amount on the cash card.

### RELATED APPLICATIONS

The present application is related to and claims the benefit of U.S. Provisional Application Ser. No. 60/181,224, filed on Feb. 9, 2000, entitled “System for Secure and Efficient Internet-based Payments Linked to Checking Account,” and U.S. Provisional Application Ser. No. 60/181,225, filed on Feb. 9, 2000, entitled “Method and System for Making Anonymous Electronic Payments on the World Wide Web,” both of which are expressly incorporated in their entirety herein by reference.

### TECHNICAL FIELD OF THE INVENTION

This invention generally relates to electronic commerce on the World Wide Web (the “Web”) and, more particularly, to methods and systems for making anonymous electronic payments on the Web.

### BACKGROUND OF THE INVENTION

The Web has evolved into a new commercial environment with enormous potential. Fueled by its universal appeal, instant and worldwide access, ease of use and low cost of operation, the Web has been the location of choice for a surprising number of merchants, vendors and service providers alike.

To realize the full commercial power of the Web, however, it is necessary to provide efficient payment mechanisms. With a payment-processing infrastructure in place, user (customer) transactions can be completely performed online without requiring telephone or other forms of personal communication. This capability is translated to more efficient payment processing, smaller operational costs and, more importantly, a very convenient “click-and-pay” method and system for users to use. All of this further enhances the Web's potential to bring higher revenue to online merchants.

The current payment method of choice for the majority of online shoppers is credit cards. Although the use of credit cards is a convenient and commercially-accepted method of payment, the use of credit cards presents a variety of problems for customers and merchants alike. First, customers must obtain a credit card account, which is a problem for potential customers who can not, or will not, get a credit card account. Even customers who have credit card accounts are reluctant to use their credit cards online, because of the many ways credit card information may be stolen and misused. Other customers are dissuaded from using credit cards over an untrusted and insecure medium, such as the Internet, because of a perceived lack of privacy. Consequently, a lot of revenue is lost because potential customers can not or will not use credit cards online.

For merchants too, the current payment process is not time or cost efficient. For example, merchants have to pass an account setup screening process similar to the one cardholders must pass. Merchants also must pay large set up and transaction costs, and put a lot of time and effort into clearing every single transaction. Despite current safeguards, merchants are often unable to coelect many payments due to fraudulent and unauthorized use of credit cards.

For these reasons, more convenient and cost-efficient payment methods have been sought in the past. Examples include electronic cash systems (such as DigiCash and CyberCash), electronic credit card systems (First Virtual, SET), telephone-based Internet payment systems (eCHARGE, iBill), and micropayment systems (Micromint, Millicent). A description of these systems follows:

CyberCash

CyberCash makes software for secure financial exchanges via the Internet. CyberCash acts as a gatekeeper linking the Internet to bank networks using security based on cryptographic authentication and encryption. The user sends CyberCash their credit-card number or bank account information, and CyberCash gives them an “electronic wallet” that records their transactions over the Internet, encrypts the payment, and sends it to the merchant. In its instabug model, the user establishes a pre-paid instabug account. Buyers hit the “pay” button on the World Wide Web page to transfer the funds from their accounts to the merchant's CyberCoin cash register.

DigiCash

Digicash's electronic cash, called eCash, is paperless money that can be transferred on the Internet. A computer user withdraws eCash electronically from a bank that also subscribes to the system. The digital dollars are stored on the user's hard drive and can then be used in a transaction with an online merchant who accepts eCash.

eCHARGE

A user chooses a product at a web page where eCHARGE is available, where the freely available eCHARGE software automatically downloads and connects the user's computer to a 1-900 number. Charges for the product later appear on the monthly local telephone bill.

E-cash

E-cash is an instantiation of DigiCash's eCash which is used in conjunction with the Mark Twain Bank to allow “authentication” of digital cash withdrawals from bank accounts. A software program enables storing the withdrawn digital cash on the user's computer hard disk. This stored “cash” can then be transferred to a seller's machine. In this system, participants must set up a World Currency account provided by the Mark Twain Bank.

First Virtual Holdings

To use the First Virtual Holdings system the users opens an account and is given an Identification (ID) number which is sent to the merchant via e-mail. The merchant forwards the e-mail to First Virtual to verify the user's ID number. First Virtual then sends an e-mail message to the user to verify the transaction. First Virtual performs the actual transfers over a private off-line network using Electronic Data Systems (EDS).

iBill

Similar to eCHARGE, users can bill one-time charges with iBill's Web900 service for access and services directly to their phone bill. The Web900 Instruction Page on the merchant's web page tells users how to dial an appropriate iBill-maintained 900 telephone number to pay for their purchase. When the user dials the 900 number, iBill's automated voice system reads out a series of numbers. The user then returns to the merchant's site and enters these numbers in order to redeem their purchase.

Millicent

Millicent, offered by the Digital Equipment corporation, is electronic “scrip” in the form of a signed message carrying a serial number and an expiration date. An authorized broker will buy Millicent scrip from one or more merchants at a volume discount and then sell it to users, who will receive and then spend it over the Internet.

NetBill

NetBill is an alliance between Carnegie Mellon University and Visa, designed to allow information to be bought and sold over the Internet. Users deposit money into a NetBill account which is drawn upon by NetBill when purchases are made.

Smart Cards/Stored Value Cards

Many prior art schemes involve the use of smart cards and stored value cards at a user's computer via a personal swipe or chip reading hardware that would read the value of the stored currency on the card's embedded computer chip, and transfer purchasing information online to an accepting merchant. The same system can be applied to credit cards and bank-issued debit cards.

SET

Secure Electronic Transactions is a system designed by MasterCard and Visa to allow secure credit card transactions over the Internet. The system requires credit card clearing houses, merchants and users to download and install the appropriate software. The credit card information is sent encrypted between the user and the merchant and is verified at the clearing house, without exposing it to other users of the Internet or to the merchant himself. Digital signatures authenticate each transaction for future auditing.

The online market, therefore, still lacks a simple and easy-to-use “click-and-pay” method and system of making electronic payments which promotes spur-of-the-moment paying habit and which affords anonymity, security and accountability.

### SUMMARY OF THE INVENTION

The methods and systems consistent with the principle of the present invention allow purchases over the Internet and from physical point-of-sale (“POS”) locations using Internet-enabled cards that can be, among other things, activated, deactivated, reloaded, and used for payment, preauthorization, or to obtain refunds, at any POS terminal or ATM location. Internet-enabled cards consistent with the present invention may contain balances in one or more currencies, or may be activated in one currency and later converted into a different currency. Methods and systems consistent with the present invention allow cardholders to review card balances or a transaction history online, change PINs, and transfer monetary value between cards or accounts. By escrowing of transactions according to the methods and systems described in this specification, the escrowing party can guarantee that a transaction has been completed before funds are released from buyer to seller, whereas both the seller and the buyer can remain anonymous if they so wish.

### BRIEF DESCRIPTION OF THE DRAWINGS

The accompanying drawings, which are incorporated in and constitute a part of this specification, illustrate an implementation of the invention and, together with the description, serve to explain the principles of the invention.

FIG. 1 is a block diagram of a communication model consistent with the present invention;

FIG. 2 depicts a flow chart of the steps performed when performing a sale at the point-of-sale (POS) in accordance with methods and systems of the present invention;

FIG. 3 depicts a flow chart of the steps performed when signing up an online merchant in accordance with methods and systems of the present invention;

FIG. 4 is a flow chart of an online payment process in accordance with methods and systems of the present invention;

FIG. 5 depicts a more detailed diagram of the server depicted in FIG. 1;

FIG. 6 illustrates the steps of the processes of activation or deactivation, reloading, or purchasing with cash back;

FIG. 7 illustrates a method for performing preauthorization consistent with the present invention;

FIG. 8 illustrates the steps of an online auction method consistent with the present invention;

FIG. 9 illustrates the steps of a method for resolving a dispute initiated by a buyer; and

FIG. 10 illustrates the steps of a method for resolving a dispute initiated by a seller.

### DETAILED DESCRIPTION OF THE INVENTION

The following detailed description of the invention refers to the accompanying drawings. Although the description includes exemplary implementations, other implementations are possible, and changes may be made to the implementations described without departing from the spirit and scope of the invention. The following detailed description does not limit the invention. Instead, the scope of the invention is defined by the appended claims. Wherever possible, the same reference numbers will be used throughout the drawings and the following description to refer to the same or like parts.

Overview

The commercial power of the Web has not yet been fully utilized. One hurdle to date has been the lack of an easy to use “click-and-pay” computer-based electronic payment method and system. Such a system would translate to efficient payment processing and smaller operational as well as convenience for users who wish to buy goods over the Internet, all of which further enhance the Web's potential to bring higher revenue to online merchants. Methods and systems consistent with the present invention enable users to buy cash cards at, for example, a convenience store, activate a card by selecting a personal identification number (“PIN”) at a specified server, click on a payment button at a site of choice, and enter the card number.

Merchants may also register at a server to open an account and download payment software which can be inserted into any web page. Computer-based methods and systems consistent with the present invention offer user anonymity (via the anonymous purchasing channel), accountability, simplicity, speed of use, and the ability to accept micropayments.

Methods and systems consistent with the present invention make electronic verification more efficient and convenient. Cash cards consistent with the present invention allow payments on the Web without requiring an account to be set up and offer anonymity to the users. Users do not need to open and account or download special software. This allows every user to shop, and promotes “spur-of the-moment” purchasing behavior.

The World Wide Web

The Web is a globally-connected network and operates on a client/server model. To use the Web, a user makes an Internet connection using a computer called a Web client and launches a Web browser, such as MOSAIC®, NETSCAPE® or INTERNET EXPLORER®. The Web client contacts a Web site on a server and requests information or resources. The server locates the information and then sends the information to the Web browser, which displays the results.

On the Web, users may view multimedia Web pages composed of text, graphics and multimedia content, such as sound and video. Users may enter a Universal Resource Locator (URL) in the browser specifying a location (server) to visit. The user may also “click” on a link to forward the user to a new location.

When a server finds the requested web page, document, or object, the server sends the information back to the Web browser. A Web browser displays information by interpreting the Hypertext Markup Language (“HTML”) used to build web pages. Coding in the HTML files tells the browser how to display the text, graphics, links and multimedia files on the web page. The browser may also use references in the HTML file to find the files on servers, and display as a web page in the browser.

The Web browser typically runs application programs that are written in JAVA®, a computer language developed by SUN MICROSYSTEMS®. JAVA® is a object-oriented programming language that allows programmers to create interactive programs and add multimedia features to web pages. NETSCAPE is an example of a Web browser capable of running JAVA® programs. JAVA® programs that run at the client inside a browser are called “applets.”

When a user visits a Web site or server that contains JAVA® applets, each applet is downloaded to the user's computer from the server. Once the applet is downloaded it runs automatically. Businesses now use the Internet to market and sell their products and many people use the Internet to browse through catalogs and make purchases online.

The nature of the Internet, however, is that it is an insecure network. As data packets travel across the Internet, any user could conceivably examine the packets and have access to the user's information. Because the Internet is inherently insecure, there are potential dangers to doing business online. If a user provides credit card information on the Internet, a third party could steal the credit card number and other identifying information. Information transmitted over the Internet may be protected by using encryption. Methods and systems for providing data security using encryption are well known to those skilled in the art. Encryption and exemplary methods for performing encryption are described in more detail Bruce Schneier, Applied Cryptography (2^{nd} ed., John Wiley & Sons, Inc.), 1996.

Architectural Overview

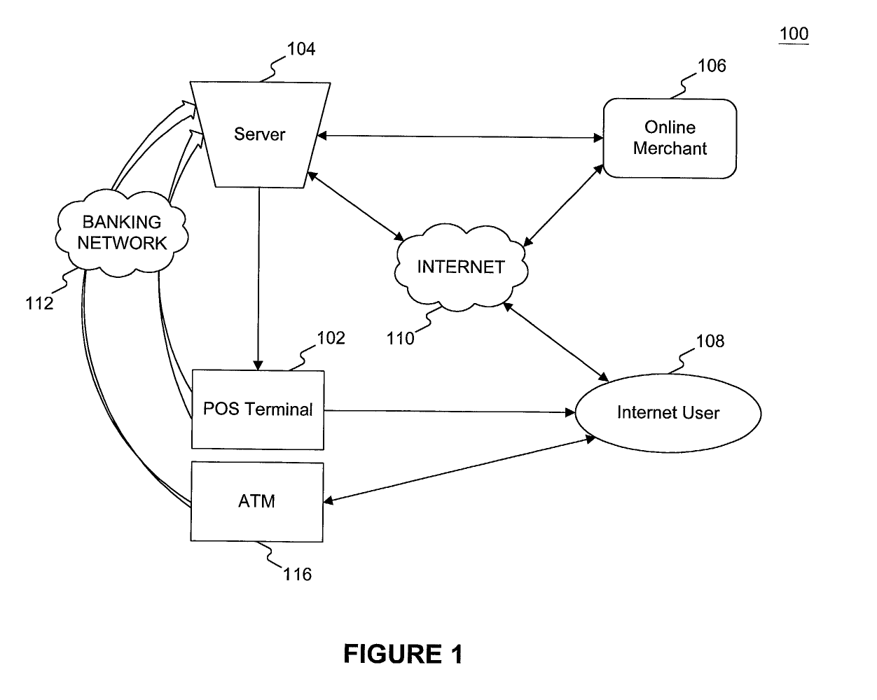

Methods and systems consistent with the present invention disclose a communication model, underlying cryptographic algorithms, and system requirements that are simple to use while enhancing security, anonymity and accountability. FIG. 1 pshows an embodiment of a communication model 100 consistent with the principles of the present invention.

In model 100, cash cards are first transferred to a physical point-of-sale (POS) terminal 102. POS terminal 102 may be located in any physical store, such as a supermarket, pharmacy, convenient store, or be a dispensing terminal similar to an automated teller machine (ATM). Prior to activation, the cash cards are inactive which makes the value of the cash cards negligible. Because of the low value of the cash cards, the cash cards can be supplied using the same channels as other physical products and do not need to be transported with security or kept in a secure location.

Activation Procedure

Before the cash cards are usable, an activation procedure is performed. In one embodiment, the cash cards are activated at the time of purchase. In the case of a POS at a physical store, activation may be performed via online communication with an online banking system server 104, such as InternetCash. The online communication may be through pre-existing means, for example, a card reader with dial-up capabilities or manually via the telephone.

A store PIN and a store identifier (“SID”) may be used for accountability of activated cash cards. The SID may be used as a unique store or terminal identifier and as a countermeasure against brute force attacks against the PIN. In some embodiments consistent with the present invention, the SID is kept secret and, if possible, sent to server 104 upon card activation. In other embodiments, the store PIN is used as an identifier instead.

Similar to the SID, the PIN prevents impersonation of a store clerk and false card activation. In general, the larger the PIN number, the lower the risk of the PIN being decoded. Large numbers, however, are inconvenient for store clerks and may lead to typographical errors so in some embodiments consistent with the present invention, a store PIN of 4-8 digits is used. Other security measures, such as tracking of repeated failed logins using the PIN, may also be taken to prevent brute force attacks. Stores may use the same store PIN for all clerks. Alternatively, the PIN may be used for indicating the function of card activation.

Cash cards may also be purchased from ATM terminal 116. ATM-dispensed cash cards may be activated, for example, by online communication (described above), or by off-line activation. One example of an off-line activation occurs when an ATM terminal prints out an “activation receipt” corresponding to a specific dispensed card. This receipt contains a portion of the secret number required for card usage. In either case, the ATM terminal 116 should be physically secure because it holds cash (either dispensed to customers or received from customers) and a secret key used either for secure online communication or for generation of an “activation receipt.” In an alternative embodiment, ATM terminal 116 may hold cash cards that have been activated thereby having cash value.

In addition to the activation procedure at POS terminal 102 or ATM terminal 116, the user may perform an additional authorization procedure. A user may, for example, log into server 104 and be asked for the number of the dispensed card and a card secret code (“CSC”). Alternatively, first time users may need to be pre-authorized by server 104. Server 104 may ask the user for the card number and CSC again. Server 104 subsequently accesses the record of the entered card number, verifies the CSC, and that the card has not previously been authorized. Server 104 asks the user to enter a User Personal Security Code (or UPIN) of any length, however, in many embodiments the UPIN is between 4 and 8 characters. The UPIN and associated card number may be stored in a database at server 104, such as an ORACLE database®. The activation procedure also affords added security to the user, by not allowing a lost card to be spent if the UPIN is not available.

“Click-and-pay” methodology using a cash card consistent with the present invention will now be explained. First, a user 108 logs in to a web site associated with online merchant 106 and after selecting a product or service, clicks, for example, a “click-and-pay” button. If user 108 is a first-time user, user 108 may be transferred to server 104 to download any required software. If the user is not a first-time user, or once the software is downloaded, a window at the user's computer requesting a prepaid cash card number may be displayed. Payment information may also be displayed in the window for user verification. A merchant number and transaction-specific number may be stored at the user's computer for future accountability.

After entering the cash card number in the display window, a payment-specific authentication number (“PAN”) is sent to server 104 (or the merchant forwards it) along with the payment data and the cash card number. The PAN is an authentication of the payment information that functions as a Message Authentication Code (MAC). MACs can be any length, however, to prevent collision attacks or other security breaches, MACs of at least 160 bits are recommended. MACs can also be based on a hash function, such as the well-known SHA-1 functions. Once server 104 receives the PAN, server 104 may process the transaction. Server 104 verifies that the cash card is active, the PAN has been computed correctly, and the requested payment amount is available on the card. If the cash card is active, the PAN is correct and the requested payment amount is available, server 104 subtracts the payment amount from the card and credits the payment amount to the merchant's account. Server 104 returns an acknowledgment to merchant 106 as well as user 108. Alternatively, merchant 106 may forward the acknowledgment from server 104 to user 108. This information may also be stored at user 108's computer. If the payment transaction succeeds, merchant 106 may provide the product or service to user 108 using any well-known delivery service, such as UPS, or by electronic delivery, such as over the Internet or other network.

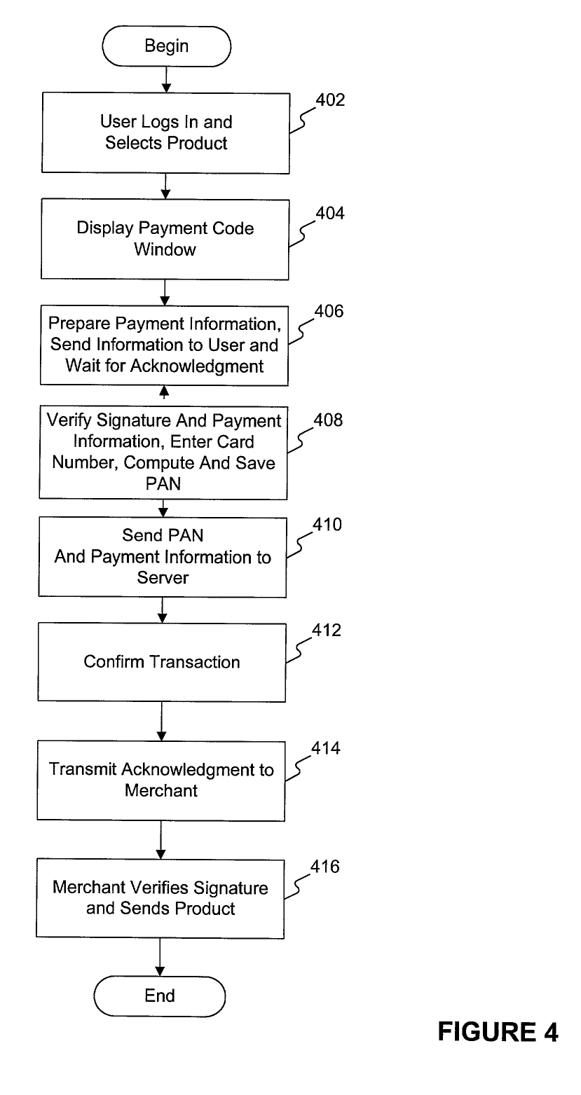

If merchant 106 fails to deliver the product or service once the card has been debited, user 108 may contact server 104 and provide the payment data and the transaction-specific number (PAN) previously received during the processing of the transaction. Server 104 may determine if user 108's card has been charged for this transaction. If user 108's card has not been charged, the transaction data is deleted from the database. If user 108's card has been charged, but merchant 106 did not provide the requested product or service, or user 108 has not received them and acknowledged receipt, this is an exception condition, which may be handled according to a policy established by the merchant and/or server 104. Server 104 may also log such events. The click-and-pay methodology is further described below with reference to FIG. 4.

Cash Cards

Consistent with the present invention, cash cards that may be used for payment on the Web will now be described. In one embodiment, the cash cards have a magnetic stripe and are dispensable by store clerks. On their backside, the cash cards may include such information as a card ID, a CSC, and optionally, directions for using the card and a server's telephone number. If present, server 104's telephone number may be used for dialing in for online verification; otherwise online verification is performed via the magnetic stripe, as explained below.

Each cash card has its own card ID (CID). The CID is a character alphanumeric code comprised of numeric digits and letters. The CID may be any size, however, a longer CID will provide more unique CIDs. For example, for a CID with a length of 6, there are approximately two billion possible CIDs since each alphanumeric character represents 10+26=36 different combinations.

In embodiments consistent with the present invention, the CID number does not need to be kept secret and may be visibly displayed on the card. The CSC, however, provides security for the card and should be kept secret. The CSC is a character alphanumeric code that may be comprised of the same numbers and letters as the CID, but it is not displayed on the card; only the user has the CSC. The CSC is further described below.

The directions for using the card may include instructions for verifying that the card was indeed activated (an activation receipt may be printed out at POS terminal 102) and that user 108's computer is using authorized software at payment time (the payment window). The software may be verified by, for example, downloading it securely from server 104, verifying that code (e.g., applets) downloaded from a merchant is digitally signed by server 104, or verifying that the payment window is reserved from server 104.

The magnetic stripe may also contain a Bank Identification Number (BIN), the CID, and server 104's telephone number. In some embodiments consistent with the present invention, the cash cards use a scratch panel to hide the CSC. Once a user buys the card the user may scratch off the scratch panel to reveal the CSC. Since the card contains hidden information, only user 108 knows the number.

Alternatively, cash cards without scratch panels are similar to the cash cards with scratch panels in that the CSC is typed on the card and covered. cash cards without scratch panels, however, may be glued to a paper holder or other means of masking the number and, thus, the CSC may only be seen after user 108 has removed the card from sits holder or removed the mask from the card. Alternatively, the holder completely encloses the card, so that the CSC is not exposed unless the cover is ripped opened. The cash cards may contain a warning that the cash cards should not be purchased if the holder or mask has been removed or scratch panel has been scratched off.

An alternative to magnetic-stripe cards is a simple flexible plastic card containing the same information as the magnetic-stripe card. With the plastic cards, however, a store clerk first dials up server 104 and enters the CID to perform online activation. Alternatively, these cards are activated at shipping time and do not need to be activated at the time of sale. As with magnetic-stripe cards, plastic cards may comprise a scratch panel or other means for protecting the secret code.

Cards may also be dispensed from an unmanned ATM-style terminal. These dispensed cards do not need a magnetic-stripe or a scratch panel because there is no human involvement and, as such, there is no danger of stealing the CSC code. Instead, the CSC is calculated and given to the user by the terminal. This calculation is performed using a terminal-specific secret key (TSK) and a cryptographic one-way or hash function. The TSK is further described below.

The CSC is either printed on the card at the time of sale, on a separate “receipt” paper, or is simply shown to user 108 who is prompted to write the code on the card. The dispensed cards may be made of any material, such as paper or plastic and may comprise a magnetic stripe. Alternatively, paper cards may be printed on the fly by an ATM terminal thereby requiring no dispensing system. Paper cards contain the CID and, optionally, directions for usage. The ATM may print the card and include the CSC on the card.

In an alternative embodiment, pre-activated cards may be dispensed from separate canisters within ATM 116. ATM 116 may also have separate canisters that hold other products, such as stamps, or checks. ATM 116 includes software that prompts user 108 and subtracts funds from a user 108's account when user 108 purchases items from the canister. Cash cards may be dispensed from ATM machines using these canisters.

POS Sale

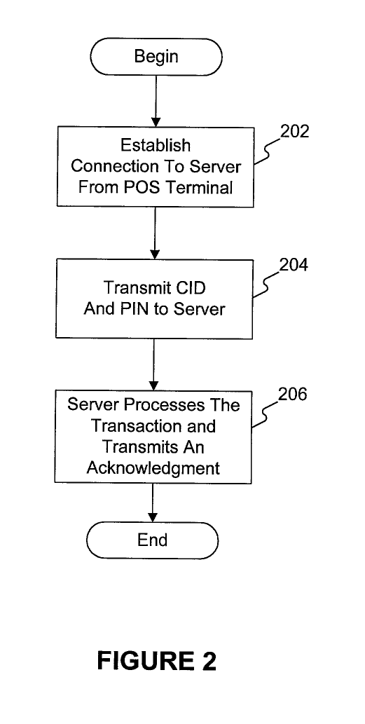

FIG. 2 illustrates a method for performing a sale at POS Terminal 102 consistent with the principles of the present invention. Store sale, the card may be activated by a store clerk.

First, a secure connection to server 104 is established (step 202). The connection may be established by, for example, dial-up session or Internet connection. If a magnetic card is used, the dial-up connection may be performed by using an existing card-reader with dial-up capabilities used for credit card authentication. In this case, the BIN number and/or the telephone number of server 104 may be encoded on the magnetic stripe so all that the clerk need only slide the card through the reader and select the appropriate button for card activation.

Once connected, the store clerk may input a CID and a store-specific PIN which transmitted to server 104 (step 204). Alternatively, the CID may be encoded on the magnetic stripe and automatically to server 104 upon sliding the card through the card reader. The clerk may input a store-specific PIN to activate the card. In some embodiments, cash cards may be activated in batch form, (e.g., five or ten) such that (each card need not be activated as it is sold. In a batch mode, the clerk inputs the batch number of the cash cards, which identifies that particular batch. If the dial-up device Supports encryption and authentication, the batch mode may be utilized over this link.

Next, server 104 may process the transaction (step 206). During processing, server 104 activates the particular CID or card. The store's PIN may be saved together with the activation record (CID or batch and timestamp). Merchant 106 may be charged immediately or periodically, such as once a day. In addition, an acknowledgment may also be returned as part of processing the transaction and a receipt may also be printed for user 108.

Alternatively, the POS method may be performed by an unmanned sale. Depending on the payment scenario, either a secret key inside POS terminal 102 needs to be secured or POS terminal 102 may have a secure dispensing canister (in the case where the card is paid for by withdrawing cash directly from a user 108's bank account). In the case where user 108 pays by cash, POS terminal 102 should also accept cash. For example, ATM machines require both a secured secret key and the ability to store cash and also include secure dispensing canisters.

There are several scenarios for the unmanned sale, depending on both POS terminal 102 and type of card used. For example, in an ATM-bundled sale, a bank ATM may provide user 108 with an additional choice of “Buying a cash card.” If user 108 desires to purchase a cash card, user 108 may select desired values, such as ten dollars or one hundred dollars. The ATM withdraws an appropriate amount from user 108's account and prints the card including, for example, the CID, CSC, directions for use and a transaction receipt. Alternatively, a set of blank cards may be located next to an ATM and user 108 may be required to write (with an attached pen) the CID and secret code on each card. The ATM may then notify server 104 that a specific card has been sold.

Alternatively, ATM 116 may notify server 104 at a later time, such as once every night for all cards sold that day. ATM 116 may further possesses a list of available CIDs and a secret key which can be used to compute the card's secret code. The CIDs are unique in that they do not require explicit activation, and activated in advance. Security may also be provided by a controlled generation of the secret codes, based on an ATM's secret key. An ATM secret key (TSK) is specific to each ATM and used to compute the CSC. The secret key is inserted securely (for example, by designated personnel, or via a secure channel) and is generated by server 104 based on a master key and a unique identifier, such as the exact location and bank name of a particular ATM. In an alternative embodiment, pre-activated cash cards in a secure dispensing canister and after collecting money from user 108 may dispense the cash cards similar to how cash are dispensed. In this case, cash cards are formatted to a size similar to a paper bill and include a scratch panel similar to the cash cards sold by a store clerk.

In an alternative embodiment, a cash-terminal sale accepts cash. Instead of accessing a user 108's bank account as in the ATM terminals, the cash-accepting terminals accept cash. A cash-accepting machine only needs means for printing receipts and does not need a display.

Additionally, a cash accepting machine may be used to dispense pre-activated cards stored in a secure canister. This machine does not need specific additions, with the only requirement being secure transfer of cash cards and positioning them into the canister.

CID Generators

Examples of CID generators, secret and master keys, and terminal identifiers will now be described.

(1) CID: In the case of point-code tracking, the CID may be a concatenation of binary digit “1” (denoting point-code tracking) and a terminal unique identifier (“TID”) to an ever-increasing serial number. Point-code tracking is defined as allowing tracing in dispensing terminals using the CID and by generating secret codes on-the-fly by unmanned terminals.

In an example where the CID is the concatenation of the TID and a serial number, the CID discloses the TID and thus the dispensing terminal. The TID number is of sufficient length so that all terminals have a unique number. Cash cards and CIDs may be generated inside a cash card terminal by using a pseudorandom or sequential algorithm. The same space on the cash cards should not used for both point-code tracking and regular cards. Regular CIDs' for example, may start with a binary digit “0.” Batch cards may also contain a batch number which can optionally be printed on the cash cards. The batch cards may be packed in batches and/or be activated in batches, either through a web interface within server 104 or through a phone interface.

(2) Internet Master Key (IMK): The IMK is created in a cryptographically secure way, and should comprise a sufficient number of bits so as to successfully prevent brute-force attacks. A “brute force attack” occurs when an attacker tries all possible values of a secret key. The IMK may contain random bits that are processed by a cryptographic function, such as a one-way hash function. These random bits may be created as a combination of inputs, including the server administrator's keystroke, mouse movements, hard-drive speed variations, operating system state, time variations between hardware clocks, or other hardware sources of randomness, such as oscillators, or lava lamps.

The IMK may expire at any time and cards manufactured after that point should use a new key. To further enhance security, it is preferable that the IMK be refreshed at regular intervals (for example, annually) and be stored in a tamper-resistant hardware cryptographic device.

(3) Terminal Secret Key (TSK). CSC=H(TSK, CID), where H is a cryptographic hash function. TSK may in turn be calculated using an IMK and the TID in combination with a cryptographic one-way or hash function; for example TSK=H(IMK, TID), where H is a cryptographic hash function or a block cipher (in which case IMK is the key) whose output is casted (or truncated) to the required size for TSK.

To further increase security, terminals may be “black marked.” If the terminal's key is lost, the terminal identifier can be marked as invalid starting from the time of security breach and ending at the time where the terminal is repaired. All cards that were manufactured by this terminal during this time interval are deemed invalid.

(4) Card Secret Code (“CSC”). The CSC is used to generate the PAN, and is regenerated as follows:

CSC=H(TSK, CID),

where H is either a one-way hash function or a block cipher (in which case TSK is the used key) casted (or truncated) to a desired size for CSC (such as 11-16 alphanumeric digits). In sum, server 104 may generate the CSC given the CID and IMK. That is, from the CID, server 104 obtains the terminal identifier TID and computes TSK (TSK=H(IMK, TID)) and, finally, the CSC (CSC=H(TSK,CID)). Server 104 may now verify that the card has been generated (“activated”) by a designated terminal.

For non-point-code tracking cards, the CSC can be calculated directly from the IMK and the CID as follows:

CSC=H(IMK,CID).

Since payments are transmitted using secure transmission protocols, such as Secure Sockets Layer (“SSL”), the information is relatively secure.

(5) A PAN used for authentication may be calculated as follows:

PAN=H(CSC, UPIN, Payment Information),

where H is a hash function(or a block cipher), and CSC and UPIN are keys).

On Line Registration

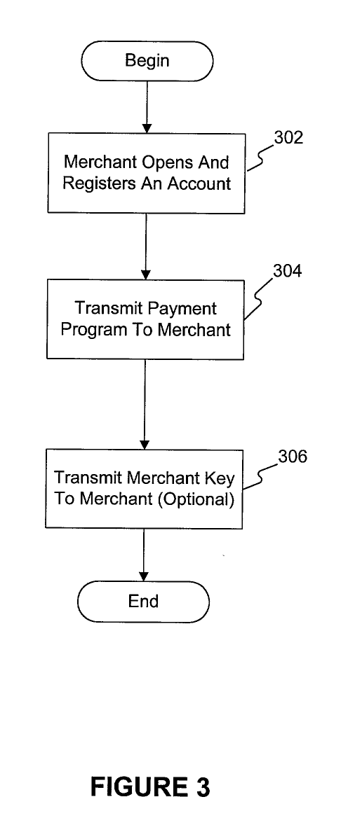

FIG. 3 depicts a flow chart of the steps performed when signing up online merchant 106 and user 108. First, online merchant 106 obtains a registration number and an account at server 104 (step 302). To register, online merchant 106 may log onto a web site and fill out an online application. Alternatively, online merchant 106 may communicate with an account representative. The application is approved either automatically or after appropriate background credit checks. Approval may depend upon the type of reimbursement online merchant 106 chooses. Once the account is opened and authorized, a merchant identification number is assigned to merchant 106 which may be different from the account number for security purposes.

Next, server 104 sends (or the merchant may download) a signed “payment program” to merchant 106 (step 304). This program may be, for example, a JAVA® applet that can then be incorporated inside any web page associated with merchant 104, or a program that includes sample web pages and other processing code that interfaces with merchant 104 associated with a back-end system. The code may be signed by server 104 based on a public key certified by a certification authority (“CA”), such as VeriSign. In embodiments consistent with the present invention, the code may come complete with everything that is needed to process a payment, such as plug-ins for merchant 106 to add payment information and code for displaying the payment information. The plug-ins may be used for information such as dollar amount of purchase, description of product(s) sold, date and time of product sold and an empty “comments” section for additional information (this acts as a “memo” on a personal check). Code sent to user 108's computer during a purchase may include programs for displaying the payment information, including merchant 106's identifying information, programs for user 108 to enter additional comments, programs asking user 108 to enter their cash card number and UPIN, and programs allowing the signing (or authenticating) of the payment information using the card's secret code and UPIN as the key.

The payment window code may be used to send the payment information and a PAN to server 104 potentially through redirection to the merchant, and waits for confirmation from server 104, including the categorized payment information. Server 104 processes the transaction received from payment window code at merchant 106 and sends a confirmation of payment to the payment code window, either directly or through merchant 106.

Additionally or alternatively, the payment program may be personalized for each merchant 106. Merchant 106's identifying information may be displayed in the program as a headline, ticker, or border of the payment window, and may be included in a signature generated by server 104. This way, only authorized merchants 106 can use the payment program, and provides for greater accountability within model 100. Server 104 may sign the payment program when merchant identifying information is added into the payment program. Server 104 may also outsource the signature authorization and certification to an external CA.

On Line Purchase Method

FIG. 4 depicts the steps performed when a user 108 uses the online payment process. First, user 108 logs into a Web site associated with merchant 106 and selects the goods or services to be purchased (step 402). If user 108 is a first-time user, user 108 may be forwarded to server 104 for downloading any of the required software (e.g., payment window code). If user 108 is not a first-time user, or once the software is downloaded, a window at user 108's computer requesting an cash card number is displayed (step 404). In response to user 108's selection of goods to purchase, the merchant payment program provides the product information, the merchant's identification number, a payment serial number, the payment amount and, optionally, a transaction timestamp to the payment code window on user 108's computer (step 406). The information may be displayed to user 108, for example, through the code (e.g., JAVA® applet), as a redirection from server 104, or through a client resident program (e.g., a browser plug-in). Once the merchant software transmits the information to user 108, the merchant payment program waits for a payment acknowledgment from server 104.

After the optional verification of the signature by the payment code window, user 108 verifies the payment information, optionally adds any comments in the comment area and enters the cash card number and UPIN (step 408). Either the payment code window or server 104 may compute the PAN based on the CSC and UPIN. Additionally, the computed information may be locally saved at user 108's computer file and indexed by the merchant's identification number and transaction number. Once computed, the payment information and PAN are sent to server 104 (step 410). Alternatively, user 108 may transmit the information to merchant 106, who may forward the payment information to server 104 (step 410).

Next server 104 confirms the transaction (step 412). During confirmation, server 104 may access a card repository file indexed by CID, verify the card validity, obtain or recompute the CSC and UPIN, verify fund availability, subtract funds from the card account, and credit merchant 106's account. If the payment information is not correct, user 108 may be given the option to re-enter the data. If the card has not been authorized online, (e.g., a UPIN has not already been selected), user 108 may be redirected to an online activation page located at server 104 to select a UPIN before the payment transaction proceeds. Finally, if the funds remaining on the card are not sufficient to cover the cost of goods to be sold, user 108 may be given the option of using an additional card for the remaining amount.

Upon successful completion of step 412, server 104 returns an acknowledgment to merchant 106 and user 108, indexed by a merchant number and a transaction number and a transaction timestamp (step 414). The signature may be based on an IMK. The merchant payment software and the payment code window saves this information in a local file. However, only the merchant software needs to verify the signature's validity before sending the product(s) to user 108 (step 416).

Verification of the server's signature on the payment information and PAN at merchant 106 computer are performed automatically by the payment software. This returns an “accept” code to the merchant, who may initiate the shipment process.

Disputes over payments and deliveries may be handled based on all saved information merchant 106 and user 108. If, for example, merchant 106 did not send the paid-for products, user 108 may provide the payment information and acknowledgment to server 104 to verify their validity.

### System Design

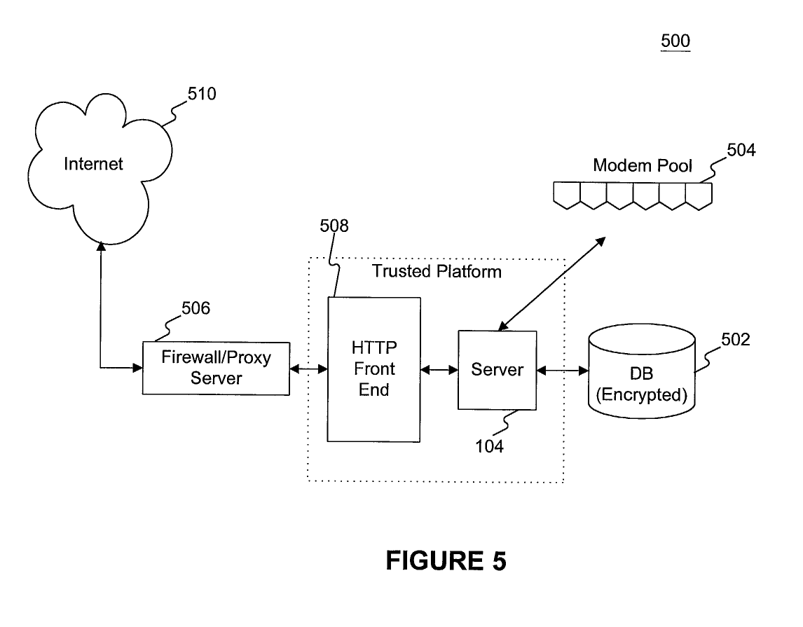

FIG. 5 depicts a system 500 running on a reliable and secure platform. Server 104 may be, for example, an NT® or Unix®-based server on a SUN® workstation. All cryptographic operations are performed inside server 104. Server 104 is connected to a database 502 that contains a list of all issued cards, separated as active and inactive, and all transactions performed by each card. Database 502 may be an encrypted and signed 24×7 database. Cards in server 104 may be indexed by the CID. Each card entry contains the manufacturing date and time, the date, time and location of activation, the total value and the remaining value. A modern pool 504 may also be connected to server 104 to accept dial-up connections from POS's. Front end web server 506 contains a firewall and an HTTP front end to provide security to server 104. The web server 506 serves as an intermediary between server 104 and network 510.

Use of Internet-Enabled Card on POS Location

Referring again to FIG. 1, when an Internet-enabled card is sold at a POS terminal 102 that is connected to banking network 112 (more secure than the Internet 110), the card can be activated while sold. Whether or not to activate a card upon purchase of the card is an option that is determined for each POS location or corporate entity. To activate a card, the store clerk or user 108 swipes the card through a debit or credit POS terminal and, if it is a debit terminal, types a PIN. The PIN may be either a variable PIN, or a PIN that determines a type of the operation to be performed by POS terminal 102.

In embodiments consistent with the present invention, the PIN may denote the operation. A PIN of “1111,” for example, may indicate “Card activation” while a PIN of “2222” may indicate “card deactivation.” A card amount is entered, and the transaction is routed through banking network 112 to server 104 for online or batch verification. In alternative embodiments, the type of operation can also be denoted by the denomination of the amount on the card. For example, a “0.01” cent denomination entered by a store clerk can denote activation. To activate a $50 card, for example, the store clerk may type in “50.01” in the number field.

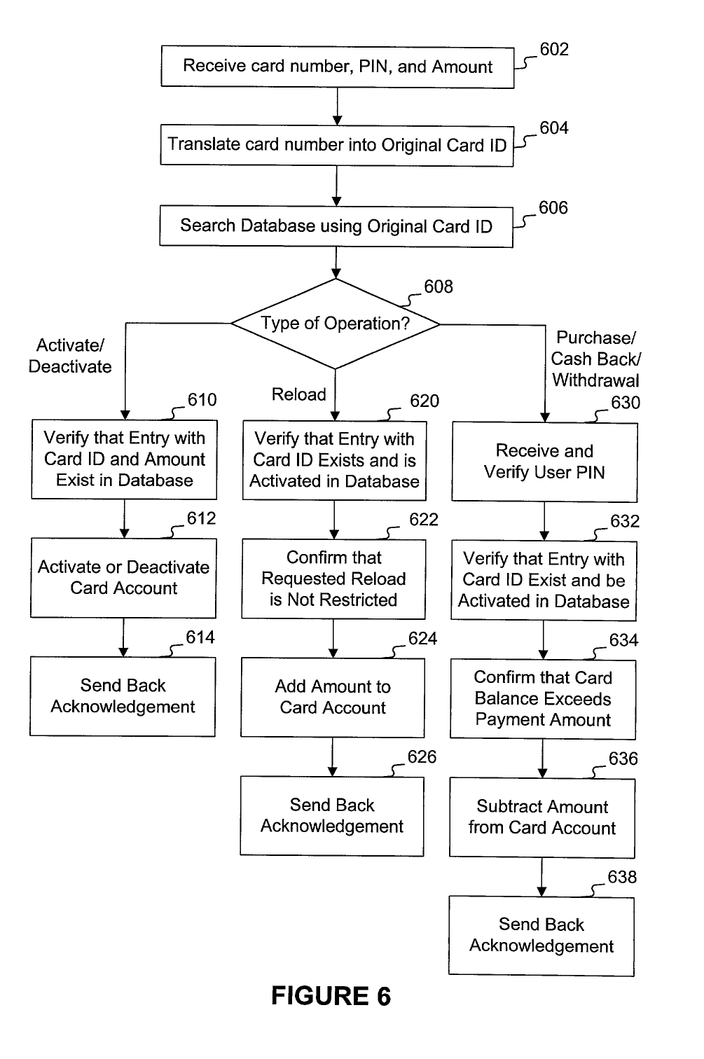

FIG. 6 illustrates the steps of the process of activating a card consistent with the principles of the present invention and with reference also to FIG. 1. As shown in FIG. 6, POS terminal 120 transmits a card number (and optionally the PIN) to server 104 through banking network 112. Card numbers consistent with the present invention are similar to those used for conventional debit, ATM and credit cards and can be transmitted through banking network 112. Server 104 receives a request containing the card number, PIN, and card amount (step 602). Server 104 may translate the card number to the original Internet-enabled card ID (step 604). The card ID, for example, may be the first nine digits of a server-assigned number. The first nine digits are sufficient to uniquely identify the card, however, the last 11 digits of the server-assigned number are needed to process the payment. Server 104 searches its database for the card ID, determines the last 11 digits from the card ID, and determines that the card number is active (step 606). If server 104 receives an request through Internet 110, the request may contain the original Internet-enabled card ID itself.

Server 104 determines the type of operation requested based on the received PIN (step 608). As explained above, if the PIN is “1111”, or the card amount is $50.01, for example, server 104 may determine that the card should be activated (step 608). If server 104 verifies that an entry having the received card ID and card amount exists in its database (step 610), server 104 may activate the card account (step 612). Subsequently, server 104 sends back an acknowledgement (success or failure of the activation) to POS terminal 102.

The card can also be deactivated in step 612. If, for example, the store clerk can not clear the purchase, the store clerk can swipe the card again and deactivate it. A time limit may also be imposed on the deactivation process, in order to limit card use to only a certain period (such as 5 minutes, 3 months, or any other time period) after the original purchase. The deactivation process is similar to the activation process, except that the PIN code that initiates it in step 610 is a different number, such as “2222” instead of “1111”, and the resulting message sent back from server 104 in step 614 is different. Similar to activation, deactivation can alternatively be signaled by POS terminal 102 based on the denomination so, for example, “20.02” in the denomination field could signify “deactivate this $20 card.”

In embodiments consistent with the present invention, user 108 can also reload a card at POS terminal 102. Reloading can be signaled by a specific PIN, such as “3333,” or by the denomination. As with activation, reloading can be indicated by adding a certain denomination, such as $0.03, to the amount added to the card. In this case, by entering “100.03,” for example, the store clerk may indicate that User 108 wishes to reload a card with $100. The reloading process can be either single-round or multiple-round.

FIG. 6 illustrates the steps of the process of reloading a card consistent with the principles of the present invention and with reference also to FIG. 1. A store clerk receives a payment amount of $X, e.g., $10, for reloading onto a card that originally held $50 but is now depleted to $Y, e.g., $35. The store clerk indicates the “Debit” key on POS terminal 102, and types “3333” to denote reloading. The store clerk swipes the icard and types the amount to reload, e.g., 10.00. POS Terminal 102 sends an authorization request to server 104.

As shown in FIG. 6, POS terminal 120 transmits a card number (and optionally the PIN) to server 104 through banking network 112. Card numbers consistentwith the present invention are similar to those used for conventional debit, ATM and credit cards and can be transmitted through banking network 112. Server 104 receives a request containing the card number, PIN, and card amount (step 602). Server 104 may translate the card number to the original Internet-enabled card ID (step 604) and search its database for the card ID verification (step 606). If server 104 receives an request through Internet 110, the request may contain the original Internet-enabled card ID itself.

Server 104 determines the type of operation requested which, in this case, is reloading (step 608). The following example describes a single-round process of reloading consistent with the present invention. Server 104 verifies that an entry having the received card ID exists in its database and it is activated (step 620). Server 104 then checks to see if the reloading request is consistent with the server's reloading policy (step 622). Server 104 can adopt any one or combination of different types of reloading policies. For example:

1. Server 104 may allow only certain denominations to be loaded, such as round dollar amounts (no cents), or only certain amounts such as $10, $20, $50, $100.

2. Server 104 may prevent a card from being reloaded to an amount that exceeds its original amount.

3. Server 104 may prevent a card from exceeding a predetermined amount, such as $100. This amount may change by locality or type of card.

4. Server 104 may prevent multiple loadings of the same card.

5. Server 104 may prevent multiple attempts at loading a card. If, for example, a card is subject to a policy that prevents a $50 card from holding from than $50, and a store clerk attempts to reload a $50 card holding $27 by adding $60, then $50, then $30, all attempts will fail. Server 104 may also block all additional attempts, even if presumably allowable (such as adding $20). The system may prevent multiple attempts, whether successful or unsuccessful, in order to prevent someone from finding the remaining balance on the card. For example, the system may only allow three attempts at reloading before blocking all subsequent attempts to reload.

6. Server 104 may prevent loading below a certain amount.

If the reloading request is allowed by server 104's policies, server 104 adds the requested amount ($10) to the card amount ($35) (step 624). The value of the card is now $35.00 server 104 also replies to POS terminal 102 with an acceptance message or a rejection message (step 626). At a physical POS location, such as POS terminal 102, the store clerk may keep or return the money to the customer depending on this message. The message sent back to POS terminal 102 may or may not list the new balance of the card.

User 108 may also use POS terminal 102 or ATM 116 to pay for things at a physical location rather than over the Internet. At a physical location, user 108 may Optionally request additional cash over a purchase price from POS terminal 102 or ATM 116. User 108 may buy, for example, $10 worth of goods, and then ask to withdraw an additional $20 from the card. In this case, the store clerk will withdraw a total of $30 from user 108 card. To server 104, however the transaction may look identical to a purchase of $30 worth of goods or may be recorded as a mixed transaction (goods plus cash over purchase price).

For this type of payment operation, any PIN code other than a set of reserved codes can be used to denote “payment.” The list of reserved codes can for example be all 4-digit equal-numbered codes: 1111, 2222, 3333,4444, etc., with or without the inclusion of “0000”. So whenever server 104 sees a PIN other than 4 equal digits in step 608, it determines this is a payment transaction and verifies the (User PIN against the card's PIN (step 630). Alternatively, two PIN codes may be transmitted to server 104; one to signal the type of transaction (received in step 602) and the other to signal the User PIN for this transaction (received in step 630). In some embodiments consistent with the present invention, User PIN may not be verified for payment, so only one PIN is transmitted.

In other embodiments consistent with the present invention, a specific denomination may be used to denote “payment.” The addition of $0.04 to the payment amount, for example, may be used to signal payment. If, for example, a user wants to pay $65, the store clerk types $65.04.

The process of payment at POS terminal 102 may also be described with reference to FIGS. 6 and 1. If a user wishes to pay for items at POS terminal 102, for example, a store clerk will total the items and indicate the “Debit” key on the terminal, if the customer is paying with a cash card. The customer may be prompted to type in a password (User PIN). The store clerk types the purchase price or, if the user wants cash back, an amount equal to the purchase price plus some amount of additional cash. As shown in FIG. 1, the terminal connects to server 104, which receives the card number, PIN, and Amount (step 602). Server 104 may translate the card number to the original Internet-enabled card ID (step 604) and search its database for the card ID verification (step 606). If server 104 receives an request through Internet 110, the request may contain the original Internet-enabled card ID itself.

Server 104 determines the type of operation requested which, in this case, is payment by, for example, distinguishing the PIN as a payment PIN (different than “1111”, “2222”, etc) (step 608). Server 104 receives and verifies that the User PIN is correct for this card (step 630). Server 104 also verifies the validity of the card (step 1632) and that the card has enough value to cover the requested amount (step 634). If the card has sufficient value, server 104 subtracts the requested amount from the card account (step 636). Server 104 replies to POS terminal 102 with message indicating that the payment transaction was successful or unsuccessful (step 638). Upon receiving a message that a payment transaction is successful, the store clerk releases the purchased items to the customer.

In addition, Internet-enabled cards can also be used to withdraw cash at an ATM location 116. The functionality is similar to that used to pay at a POS location. In this case the customer enters her/his PIN and selects to withdraw cash from their account. The ATM sends a message through the ABA network to server 104, which includes the cash card number and PIN, just like from a POS location. Server 104 processes the request, verifies that the card has enough funds to cover the withdrawal amount plus any applicable fees, and replies with an accept or deny message accordingly.

PINs may be of any length and contain non-numeric characters, however, choosing a PIN that contains other than the numeric characters 0-9 may make it difficult to use the card with conventional equipment that comprises only a numeric keypad. If a card holder chooses a PIN that contains non-alphanumeric characters, or is longer than 112 characters, methods and systems consistent with the present invention comprise means for accepting such non-standard PIN numbers. For example, customers may be instructed to type “0” instead of any non-alphanumeric character in a PIN (i.e., all non-alphanumeric characters are mapped to “0”), or to ignore any character after the 12^{th} character.

Another limitation on PIN handling is that some intermediate processors that route ABA-based debit or ATM transactions requiring a PIN always check that the PIN corresponds to a PIN offset that is encoded in the card's magnetic stripe. The magnetic stripe, however, needs to be encoded at a physical device, and Internet-enabled cardholders usually select a PIN over the Internet. In embodiments consistent with the present invention, the magnetic stripe may not include any PIN offset information and intermediate processors may instead be instructed to ignore the PIN offset. Alternatively, the card encodes a specific PIN, which may or may not be the same for some or all cards, and that PIN is disclosed to the customer. The customer may be required to use this particular PIN for off-line (brick & mortar) purchases.

Currency Conversion

Methods and systems consistent with the principle of the invention can convert electronic cash between different currencies, thereby allowing customers to shop anywhere in the world. Online currency conversion can be performed, for example, either by transaction, all at once, or a combination. An account may be converted from one currency to another, for example, but a single transaction can occur in any other currency.

First, conversion at transaction time will be explained. In this case, a transactional request comes to server 104 just as it would normally arrive if a single currency was involved. Prior to adding value to a card, or subtracting an amount from a card, server 104 may check the currency of the card against the currency desired by the merchant. If the two currency codes are the same, then the system continues with the transaction as usual; if they are different, then the system performs an online currency conversion. Server 104, for example, may convert the amount to add to or subtract from the card to the currency of the card using a currency database containing current currency conversion rates. The conversion rate may include a commission, such as a percentage, a fixed fee, or a combination. In addition, there may be an additional percentage or fixed commission fee for each transaction. The converted amount may then be added to or subtracted from the card amount.

In another example, the card amount may be converted into the currency requested by the merchant and stored in a temporary storage location. After converting all cards that need conversion (since multiple cards with mixed currencies can be used), the regular algorithm for transaction processing is used, with the appropriate amounts are subtracted from each card. The remaining amount on each card (stored in the temporary storage location) is converted back to the currency of the card in a way that ensures the customer is charged the correct fee for the purchase (by, for example, using the same conversion rate) and is posted as the remaining amount on the card.

Optionally, server 104's may list the current conversion rate on a publicly available web site. Server 104 may also generate a currency conversion report showing the conversion that took place, the affected cards, and the current conversion rate. Additionally, the currency conversion function may be performed payment wallet, which is a software provided by server 104 and can be executed on the customer's computer to store the card number(s) and/or show the balance of each card to user 108.

In some embodiments consistent with the present invention, a user may wish to convert the whole balance on a card or account to a different currency. A user may convert the card balance over the Internet by, for example, going to server 104's web site and clicking on a “Convert currency” button on the web site. The user may be prompted to the card ID and PIN. The available balance may be displayed to the user. The user indicates a currency into which the currency should be converted. The current conversion rate may be displayed, and the user may have an opportunity to accept the current conversion rate or terminate the transaction without converting. If the user indicates acceptance of the current currency rate, server 104 converts the balance on the card amount into the indicated currency. Server 104 may perform the currency conversion using a database of current conversion rates, as described above, or a different table reflecting, for example, different transaction fees.

Internet-Based Transaction at POS Location

The Internet-enabled payment system described herein may be extended to other types of payments, such as debit or credit payments. In other words, the methods and systems described herein may be used in place of conventional electronic payment systems such as the ABA network. Any type of payment may originate over the Internet or at a physical POS location.

Referring again to FIG. 1, methods and systems consistent with the present invention may be implemented whether a merchant has Internet connectivity or not. FIG. 1 shows that POS terminal 102 at a merchant may be operatively connected to server 104 via Internet 110, banking network 112, or a direct connection 114. POS terminal 102 may also be operatively connected to server 104 by, for example, analog modem over a dial-up, cable modem, DSL, T-1, or a wireless communication mode. In embodiments consistent with the present invention, POS terminal 102 at the merchant comprises a display, one or more input devices (such as a keyboard, pin pad, or swipe terminal), and a computing device for generating a digital signature or encryption of the customer's card number and PIN. POS terminal 102 may, for example, be a personal computer. In some embodiments, a pin pad may comprise a computing device for generating a digital signature or encryption of the customer's card number and PIN.

When a customer wishes to pay for goods at a merchant with POS terminal 102, the customer's card number and PIN are provided to POS terminal 102 by, for example, manually entering the card number or swiping or scanning the card, and entering the customer's PIN. The customer authorizes the transaction by clicking/selecting the appropriate button/function. POS terminal 102 computes a payment signature (or PAN) and transmits it to server 104. The PAN can alternatively be computed by server 104 on behalf of the terminal. Server 104 then verifies the transaction and sends back an acceptance or deny, accordingly.

In conventional transactions over an ABA network, transactions are transmitted in the clear (because the ABA network is presumably secure) and only the user's PIN is encrypted. Methods and systems consistent with the present invention, however, compute a digital signature of the card number, customer PIN, and other transaction data that is only valid for a particular transaction, thereby preventing replay attacks.

Additionally, methods and systems consistent with the present invention allow use of a merchant signature generated using a key associated with the merchant. The merchant's key can be entered to the merchant terminal in a variety of ways: manual entry, swipe card in combination with PIN, download application, or some other method. For example, at a POS terminal at a merchant, after the customer's card and PIN are received by the POS terminal, a PAN may be computed as follows:

PAN=E_{MK}[A={Merchant ID, Transaction ID, Card ID, Amount, Description of Goods, Date/Time, S_{PIN}(1,tag,CardID, Amount, Merchant ID, Transaction ID, Description of Goods, Date/Time, tag,1)}, S_{MK} (A)],

where E is a symmetric encryption algorithm of pre-specified strength, e.g., 3-DES CBC with a 168-bit key MK, and S is a symmetric or asymmetric signature algorithm, such as HMAC-SHA1 or elliptic curve. MK is a merchant Key that is created by, for example,

MK=HMAC_{SCMK}(MerchantID, Text A, “Version 1”),

where Text A is a piece of text used as input to alter the result of the HMAC. Consistent with the present invention, the same Merchant ID may be used to generate different keys for different reasons such as, for example, MK1=HMAC_{SCMK}(MerchantID, “InternetCash POS purchases”, “Version 1”), MK2=HMAC_{SCMK}(MerchantID, “InternetCash Card purchases over the Internet”, “Version 1”), MK3=HMAC_{SCMK}(MerchantID, “InternetCash POS purchases”,“Version 2”), etc. Text A can be any input, actually, so long as it modifies the HMAC. Additionally, two iterations of the HMAC may be run if more than 160 bits of output are required for the key. In an alternative embodiment, the encryption function may be the identity function (that is, no encryption used).

Alternatively, public key technology may be used at the merchant location, for example,

PAN=E_{ICPK} [Sig_{MSK} [A={Merchant ID, Transaction ID, Card ID, Amount, Description of Goods, S_{PIN}(1,tag, CardID, Amount, Merchant ID, Transaction ID, Description of Goods, tag,1)}, S_{MK} (A)]],

where ICPK is server 104's public key, and MSK is the merchant's secret key generated using a public key cryptosystem (e.g., RSA). The merchant's secret keys be established at installation, determined over a network connection using a secure key exchange protocol, such as the Diffie-Hellman (D-H) key exchange algorithm, or in a hybrid manner, for example, by using an authenticated D-H key exchange (such as ElGamal key agreement).

Other Operations

In some embodiments consistent with the present invention, a customer can visit srer 104's website to check the balance on a particular card. To achieve this, the customer enters the card number and PIN over a secure connection. Before displaying balance information, server 104 may determine one or more of the following: whether the card number is valid, the PIN is correct, the card has been paid for, and the card is activated. If one or more of the above is not true, server 104 may display an error message to the customer.

Alternatively, server 104 may obtain the customer's card number automatically and the customer need not enter the card number. The customer's card number may, for example, may be stored and accessible to the customer's web browser and displayed automatically when the customer opens an inquiry window. The customer's card number may be stored in an encrypted form and, in this case, the customer may need to enter a PIN before the customer's card number is available. This feature may also be set to expire, so that if a customer leaves the computer, a third party may not use the card number without entering a PIN. Via server 104's web site, the customer may also be able to obtain a transaction history of prior card transactions and change a user PIN

Pre-Authorizations and Refunds on Purchases

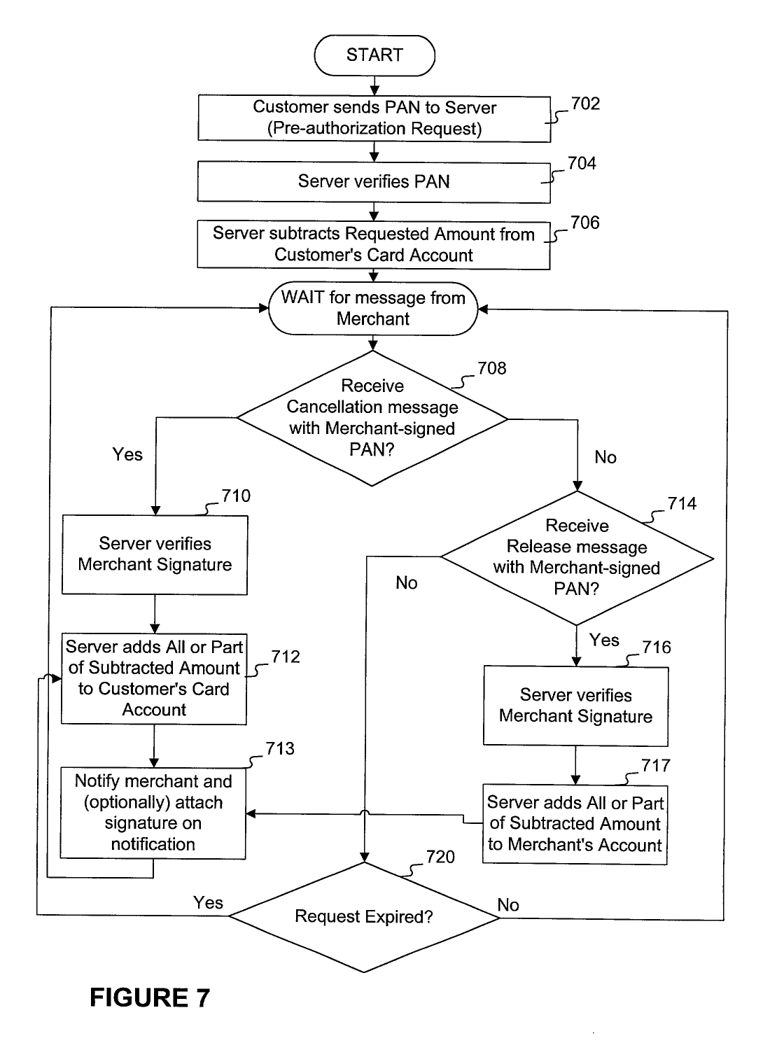

Using methods and systems consistent with the present invention, merchants can also request pre-authorizations and refunds. FIG. 7 shows a method for requesting pre-authorization consistent with the present invention, with reference to FIG. 1. As is described above, user 108's card number and PIN are entered into POS terminal 102. A payment-specific authentication number (PAN) is generated and sent to server 104 with a preauthorization request (step 802). Server 104 verifies the PAN (step 804) and, if the account contains sufficient funds to cover the purchase, subtracts the requested amount from the user's card account (step 806). If the card(s) do not have enough funds, a message with an error code INSUFFICENT_FUNDS is sent back to the merchant, which then informs the customer.

During pre-authorization, the merchant's account is not immediately credited with the payment amount, unlike a regular payment transaction. Instead, the funds subtracted from the customer's account may be put in escrow. When delivery of goods is complete, and no cancellation message is received (step 808), the merchant sends a pre-authorization funds release request to server 104 instructing server 104 to credit the merchant's account (step 814). The pre-authorization release request contains the PAN assigned by the merchant. The PAN and/or other information specifies the payment to be released. Server 104 receives the release request, verifies the merchant's signature (step 816) and adds to the merchant's account the cost of the goods successfully delivered (step 818).

If the delivery of certain goods can not be satisfied, the merchant sends a pre-authorization cancellation request (step 808). The pre-authorization cancellation request also contains the PAN signed by the merchant. The PAN and/or other information specifies the payment to be canceled. Server 104 verifies the signature (step 810) and credits the customer's account with any pre-authorized amount that has not yet been released (step 812).

A merchant may also specify an expiration date with the pre-authorization request in which case the customer's cards will be automatically credited with the remaining pre-authorization amount not released by that date. Alternatively, the funds may also be automatically released if there is no activity on the reserved funds for a predetermined time period.

A similar process is performed when a customer requests a refund. Server 104 that receives a refund request with an accompanying PAN signed by the merchant. Server 104 verifies the merchant's signature, subtracts the amount of payment specified by the PAN from the merchant's account, and adds this amount to the customer's account. Refunds are processed immediately if the merchant has enough funds to cover the refund. If not, the refund may be allowed to go through only if the merchant has available credit that will cover the refund amount. Server 104 may determine whether to process refunds from a particular merchant based on other factors, such as a merchant's credit history. If the refund does not go through, server 104 may send the merchant an error message, such as INSUFFICENT_FUND. Preauthorization requests, release requests, and refund requests may comprise one or more of the following types of information: message type (pre-authorization request), amount of the pre-authorization, release, or refund requested, PAN, merchant ID, transaction ID, currency type of the amount, description of request, expiration date of request, date of the request, and signature of the merchant.

For each of the above requests, the merchant signature may be saved by server 104 and used as proof of the request of the particular pre-authorization or refund.

After successful release or cancellation of the pre-authorized funds, the merchant or server 104 can notify the customer of the funds' status. Server 104 can also provide to merchants a sample web page from which a pre-authorization fund release, cancellation or refund can be requested. The interface can be either manually invoked by a Customer Service Representative or called automatically upon certain conditions.

Private-Label or Restricted Internet-Enabled Cards

Internet-enabled cards can be by default usable in all locations that are affiliated with server 104. Under some circumstances, however, it may be preferable to limit the use of some cards to a specific merchant site, a collection of merchant sites, or to exclude the use of some cards from a site or collection of sites.

This functionality can be performed by, for example, use of Stock Keeping Unit (or “SKU”) numbers. If cards have a particular SKU number, then they are treated in a particular way by server 104. Namely, server 104's database identifies cards whose SKU numbers signify restricted cards, and checks to see whether the card is being used in an allowed location.

Anonymous Escrowing for Person-to-Person Sales via Internet-Enabled Cards

This functionality allows users of Internet-enabled cards engaging in person-to-person sales transactions to transfer funds between Internet-enabled cards or accounts with assurance that the goods will be delivered to a buyer before the funds are released to the seller. In addition, the buyer and/or the seller may remain anonymous throughout the process if they so wish.

In online auction situations, for example, a seller and buyer may wish to exchange goods, but the seller does not trust the buyer that s/he will indeed pay for the received goods, and the buyer does not trust the seller that s/he will indeed (a) sell the goods as advertised, and (b) deliver as promised. In addition to the above, both the buyer and the seller may wish to remain anonymous. Methods and systems consistent with the present invention solve these problems with Internet-enabled cards as the payment mechanism, and server 104 as the trusted third party.

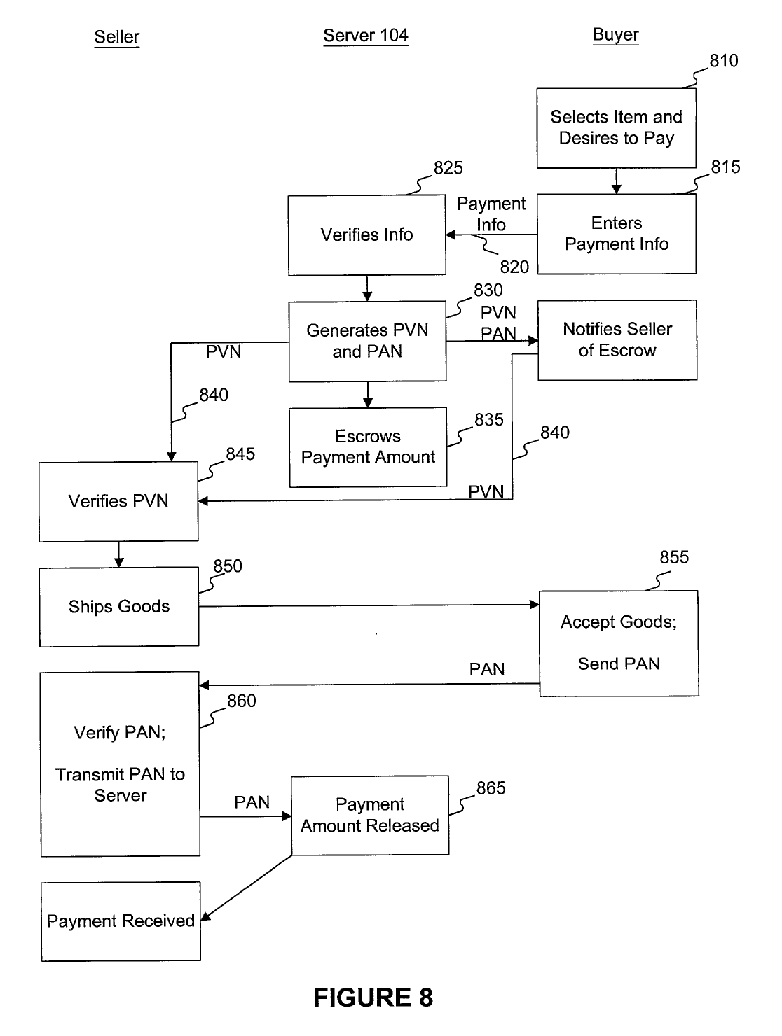

FIG. 8 illustrates the steps of an online auction method consistent with the present invention. First, a seller advertises an item at a web page (step 805). A buyer selects the item and indicates a desire to pay for it by, for example, clicking on a payment button (step 810). The buyer is prompted to enter one or more Internet-enabled card numbers and PINs, or other payment information (step 815). This information is transmitted to server 104 (step 820).

Server 104 verifies that the cards are valid, the PINs correspond to the cards, and that the amount on the cards is sufficient for the purchase (step 825). Server 104 generates a Payment Verification Number (PVN) and a Payment Authentication Number (PAN), which are transmitted to the buyer (step 830). The PAN is a one-way cryptographic message authentication function on the particular purchase, and based on the customer's cards and PINs, and the PVN is server 104's digital signature of the PAN, based on a server 104's specific key (e.g., an Escrow Key, EK). The PVN may be described as follows:

PVN=HMAC_{EK}(PAN, Seller Information, Buyer Information), where the Seller information is optional. Buyer information may be the Internet-enabled card ID of the buyer.

Server 104 subtracts the amount of the purchase from the buyer's cards and puts the funds in an escrowed account (step 835). In embodiments consistent with the present invention, indexed by the PVN. The stored information may also include the payment, seller, and buyer information, as well as the Card IDs involved, and the sequence with which they were entered.

The buyer (and/or server 104) sends a notification to the seller that payment has been escrowed (step 840). This notification includes the PVN, and indicates to the seller that the item has been paid for and it can now be shipped. A shipping address may be included in the notification. The seller verifies the received PVN (step 845). If the seller does not have the appropriate software, the seller can go to server 104's web site and execute or download a program that will perform the verification. The verification program, given the PVN, searches server 104's database for the escrowed account, and obtain the payment information, such as, for example, a description of the goods. Upon verifying that the PVN indeed corresponds to the particular items, the seller ships the goods (step 850).

When the buyer receives the goods, the buyer may release the funds by sending the PAN to the seller (step 855). After receiving the PAN, the seller visits server 104's web site and enters the seller's Internet-enabled card number (or other account) and PIN, and the PAN of the purchase (step 860). The amount of the purchase is removed from the escrowed account and is transferred to the seller's Internet-enabled card number (or other account). Alternatively, the seller may be given one or more new Internet-enabled cards whose value amounts to the escrowed amount. Server 104 may withhold a percentage or a fixed fee of the transaction to cover its costs.

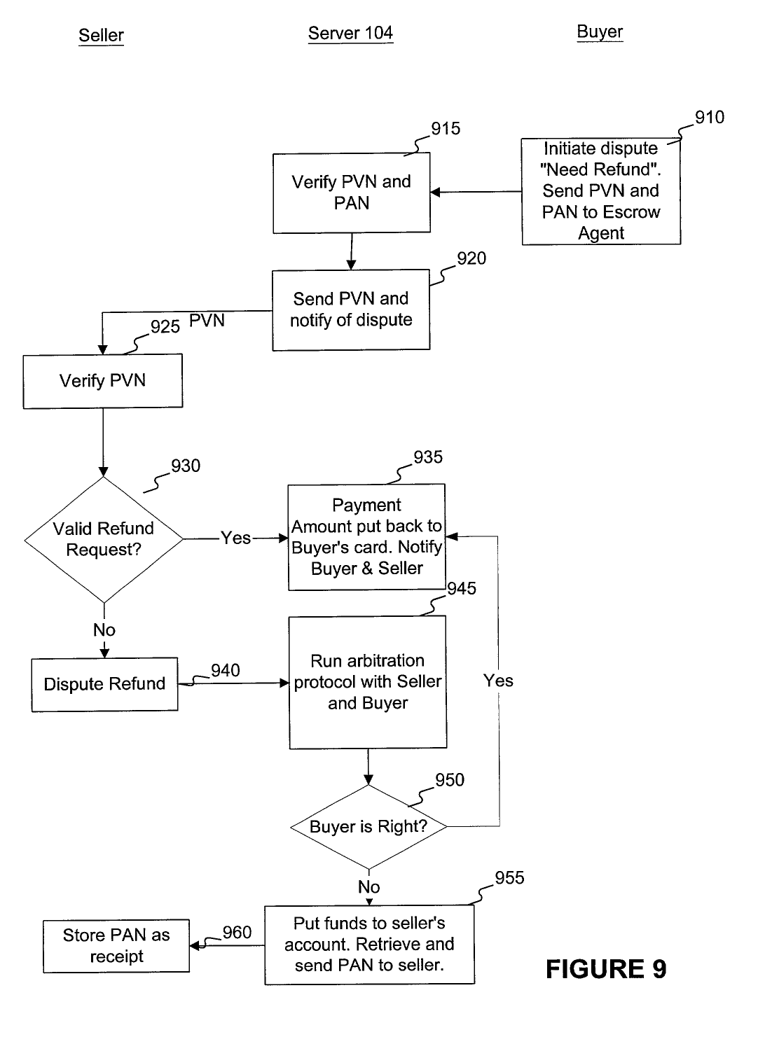

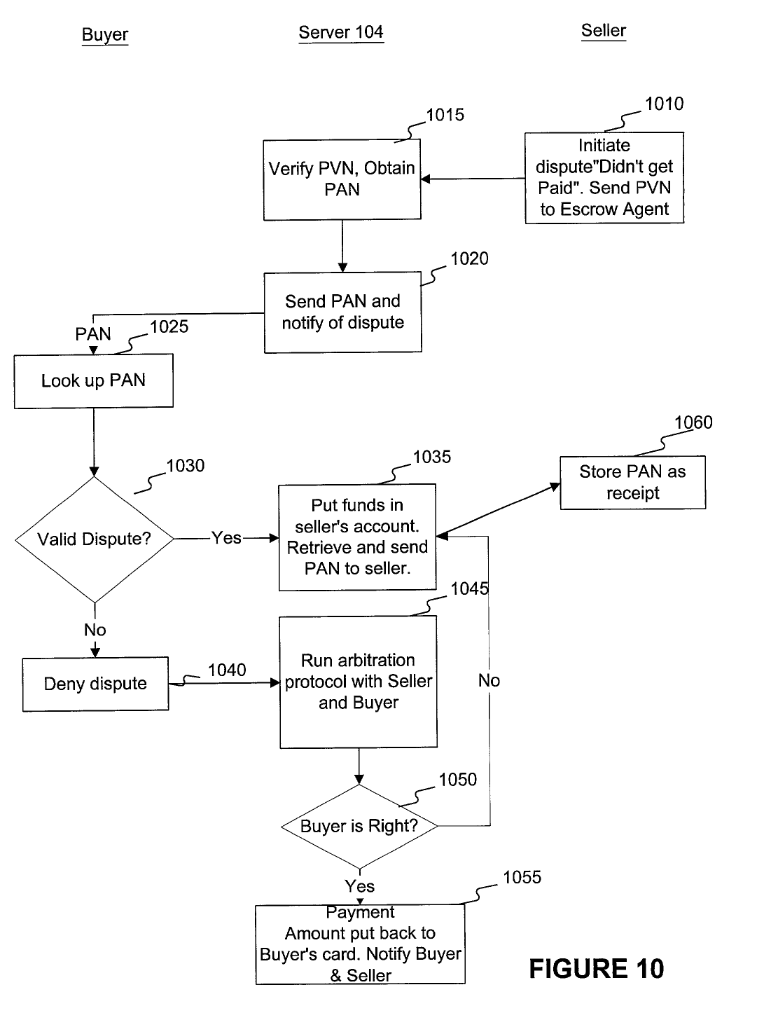

In escrowing situations, the trusted third party may participate in resolving disputes, such as, for example, when a buyer claims to have not received the item, but the seller claims to have sent it. FIGS. 9 and 10 illustrate the steps of methods for resolving disputes. As shown in FIG. 9, a buyer may initiate dispute resolution by sending a request fora refund, the PVN, and the PAN to server 104 (step 910). Server 104 verifies the PVN and PAN (step 915). Server 104 notifies the seller of the dispute and sends the seller the PVN (step 920). The seller verifies the PVN (step 925). If the refund request is valid (step 930), the payment amount is added back to the buyer's card (step 935) and the buyer and seller are notified. If the refund request is not valid (step 930), the refund is disputed (step 940). Server 104 may serve as arbiter between the seller and the buyer (step 945). If server 104 determines that the buyer is right, the payment amount is put back in buyer's account (step 935). If server 104 determines that the seller is right, the funds are put in seller's account and server 104 sends the PAN to the seller (step 955), which may store the PAN as a receipt (step 960).

FIG. 10 shows the steps when the seller initiates a dispute such as, for example, when the seller claims it has not been paid. The seller sends the PVN to the escrow agent which, in this case, is server 104 (step 1010). Server 104 verifies the PVN and obtains the PAN (step 1015). Server 104 sends the PAN to the buyer, thereby notifying buyer of the dispute (step 1020). The buyer may look up the PAN and determine whether the buyer's record shows that the seller was paid (step 1025). If the dispute is valid (step 1030), server 104 puts the funds in seller's account and retrieves and sends the PAN to the seller (step 1035). Server 104 may optionally store the PAN as areceipt (step 1060). If the dispute is not valid (that is, buyer's records show that seller was paid, the buyer denies the dispute (step 1040) and enters into arbitration by server 104 with the seller (step 1045). If server 104 determines that the seller is right (step 1050), the funds are paid to the seller (step 1035). If server 104 determines that the buyer is right, the amount is put back on buyer's card (step 1055).

Card-to-Card (Person-to-Person) Money Transfer and Other Transfers

The Internet-enabled card system in this embodiment can transfer funds to a remote individual without requiring the recipient's some sort of identifying information, such as a credit card, a debit/ATM card, or some other medium. The recipient can receive funds directly and anonymously into their Internet-enabled card. If they do not possess an Internet-enabled card, they can either buy a small-value one, or obtain a zero-value card intended solely for money transfers. The funds transfer to the card can be instantaneous and the recipient can go into an ATM and withdraw money directly from their Internet-enabled card as described earlier.

Since the Internet-enabled card system can transfer funds from one Internet-enabled card to another, transfer of monetary funds with the anonymity from person-to-person, from consumers to business, or even from business to consumers can be realized.

From the server 104's perspective, this transfer is similar to a purchase. When one card holder decides to transfer money to another card, the recipient's card number can be used as the Merchant ID of the “merchant to be paid” . Therefore the process is similar to a payment as follows.

The payer visits a web page on server 104's or an affiliate's website, where the “transfer money to another card” functionality is listed. Then the payer enters her/his card number(s) and PIN(s), the amount s/he wishes to transfer, and the Card ID (e.g., the first 9 characters of the card number) of the recipient's card. As explained earlier, the Card ID is the public part of the Internet-enabled card number, i.e., it uniquely identifies the recipient's card, but does not allow anyone to use the card for payments (which requires the secret part of the card number, the Card Secret Code, CSC). The payer is given the option to take money from more than one cards, just as is done in a regular payment transaction.

Upon the payer's confirmation of the transaction, server 104 verifies that the payer's card(s) number(s) is(are) correct, the card(s) has(have) been activated, the (PIN(s) is(are) the correct one(s) for the card(s) used for payment, and that the card has enough value to cover the payment transaction. Then it verifies that the recipient's card ID is correct, and that the card has been sold. Then it transfers the funds from the payer's card(s) to the recipient's.

Optionally, the total amount on the recipient's card after the transaction is complete may be limited to either the original face value of the card, or a predetermined fixed amount, or an amount that depends on other parameters, such as currency code, location the card was sold, etc. Also optionally, server 104 may charge a percentage of the money transferred, and/or a fixed fee for the transfer, to the payer's or the recipient's card. The resulting transaction may be reflected on the transaction history of both the payer and the payee's card.

The above functionality can be extended to allow transfers from other monetary media to an Internet-enabled card, or transfer from an Internet-enabled card to other types of accounts. For example, the payer may use her/his credit or debit card to transfer funds into an Internet-enabled card, or a checking account number, or any other method available at an Internet terminal. The recipient may also receive the funds from the Internet-enabled cards of the payer directly into her/his checking account, or into her/his credit/debit card if that is allowed by the particular institution, or via other means.

Internet-Enabled Credit Cards

The Internet-enabled pre-paid card system presented in this specification can be transformed into an Internet-enabled credit card system, i.e., allow consumers to have credit on the particular card instead of requiring pre-funding of the cards. In this case, server 104 has access certain customer data in order to determine things such as creditworthiness, credit line, etc.

The customer obtains an Internet-enabled credit card via conventional or other means, e.g., after filing an application with server 104 over the Internet, over the phone, or via regular mail. Server 104 may assign a certain credit limit to this card number or may use other means to determine whether to accept a transaction on the card or not. The Internet-enabled card is otherwise used in the same way as a pre-paid card, both over the Internet and, optionally, as described earlier, for brick and mortar transactions as well. Some or all of the additional functionality of the pre-paid Internet-enabled card described in this specification is applicable to Internet-enabled credit cards as well.

The above-described embodiments according to the present invention may be conveniently implemented using conventional general purpose digital computers programmed according to the teachings of the present specification, as will be apparent to those skilled in the computer art. Appropriate software coding can readily be prepared by skilled programmers based on the teachings of the present disclosure, as will be apparent to those skilled in the software art. Such a software package can be a computer program product that employs a storage medium including stored computer code which is used to program a computer to perform the disclosed function and process of the present invention. Also, what is described above as being stored in a memory may be stored on or read from other computer-readable media, such as secondary storage devices, like hard disks, floppy disks, and CD-ROM; a carrier wave received from a network like the Internet; or other forms of ROM or RAM.

In addition to those already mentioned above, persons of ordinary skill will realize that many modifications and variations of the above embodiments may be made without departing from the novel and advantageous features of the present invention.

Accordingly, all such modifications and variations are intended to be included within the scope of the appended claims. The specification and examples are only exemplary. The following claims define the true scope and sprit of the invention.

We claim:

1. A method for performing a cash card operation at a point of sale (POS) terminal, the cash card associated with a predetermined amount of money and comprising a first card identification number, the method comprising:
receiving a second card identification number of the cash card from the POS terminal, the second card identification number able to be mapped or translated into the first card identification number;
determining an operation based on the second card identification number; and
executing the operation by accessing an account associated with the cash card.

2. A method for performing a cash card operation at a point of sale (POS) terminal, the cash card associated with a predetermined amount of money and usable in purchases over a first network with a first card identification number, the method comprising:
receiving a second card identification number of the cash card from the POS terminal through a second network, the second card identification having a format consistent with the second network that can be mapped or translated into the first card identification;
determining an operation to be made on the cash card based on the second card identification number; and
executing the operation by accessing an account associated with the cash card, the account accessible over the first network.

3. The method of claim 1, further comprising:
receiving the first card identification number of the cash card through a first network for purchasing an item; and
subtracting the cost of the item from the account associated with the cash card.

4. The method of claim 1, wherein the operation is determined based on information received as a Personal Identification Number (PIN) along with the second card identification number.

5. The method of claim 1, wherein the operation is determined based on a denomination of an amount of money received with the second card identification number.

6. The method of claim 1, wherein when the operation is determined to be activation, the account is activated by executing the operation.

7. The method of claim 1, wherein when the operation is determined to be deactivation, the account is deactivated by executing the operation.

8. The method of claim 1, wherein when the operation is determined as reloading, an amount of the reloading paid by a customer at the POS terminal is added to the account by executing the operation.

9. The method of claim 7, further comprising:
preventing the account from exceeding the predetermined amount of money.

10. The method of claim 8, further comprising:
preventing more than a predetermined number of attempts of reloading to the account, whether the reloading is successfully executed or not.

11. The method of claim 1, wherein when the operation is determined to be payment, an amount of a payment is subtracted from the account.

12. The method of claim 10, wherein the amount of the payment includes a cost of an item purchased by a customer at the POS terminal and an additional amount of cash paid to the customer at the POS terminal.

13. The method of claim 1, wherein a user PIN entered by a customer is received along with the second card identification number, and further comprising
verifying that the user PIN is correct for the account identified by the second card identification number before executing the operation.

14. The method of claim 12, wherein the user PIN is received through a second network and has a format consistent with the second network and is obtained by translating another user PIN of the cash card for the purchase over a first network.

15. A method for enabling a customer to withdraw money using a cash card at an automated teller machine (ATM), the cash card associated with a predetermined amount of money and usable in purchase over a first network with a first card identification number, the method comprising:
receiving a second card identification number of the cash card along with a User PIN from the ATM through a second network, the second card identification number having a format consistent with the second network and translatable into the first card identification number;
verifying that the User PIN is correct for an account identified by the second card identification number, the account accessible over the first network; and
subtracting an amount of money to be withdrawn from the account.

16. A method for converting currency for a cash card usable in payment over a first network, the cash card associated with a predetermined amount of money in an account, the method comprising:
receiving a card identification number of the cash card through the first network for the payment;
determining that a first currency in the payment and a second currency in the account identified by the card identification number are different;
converting a current amount of the account in the second currency into the first currency;
subtracting the payment from the current amount in the first currency; and
converting a remaining amount after subtracting of the account in the first currency into the second currency if the remaining amount exists.

17. A method for converting currency for a cash card usable in payment over a first network, the cash card associated with a predetermined amount of money in an account, the method comprising:
receiving a card identification number of the cash card through the first network for conversion into a first currency;
determining that a customer of the cash card accepts a conversion rate from a second currency in the account identified by the card identification number into the first currency; and
converting an amount of the account in the second currency into the first currency.

18. A method for enabling a customer to make a payment using a cash card at a point of sale (POS) location, the cash card associated with a predetermined amount of money and usable in purchase over a first network, the method comprising:
receiving, at the POS location, a card identification number of the cash card along with a User PIN from the customer, and transaction information from a store clerk;
creating payment-specific authentication information from the card identification number, the User PIN, and the transaction information;
transmitting, through the first network to a server managing an account associated with the cash card, the payment-specific authentication information, such that the server verifies the payment-specific authentication information and makes the payment from the account of the customer.

19. A method for performing pre-authorization of a payment from a customer to a merchant with a cash card, the cash card associated with a predetermined amount of money and usable in purchase over a first network, the method comprising:
receiving, at a server managing a first account associated with the cash card of the customer, a pre-authorization request message including payment-specific authentication information created at a time of the payment;
subtracting an amount of the payment from the first account according to the pre-authorization request;
adding at least a part of the amount subtracted from the first account to a second account of the merchant when a pre-authorization release message including the payment-specific authentication information is received at the server; and
adding at least a part of the amount subtracted from the first account to the first account when a pre-authorization cancellation message including the payment-specific authentication information is received at the server.

20. The method of claim 19, wherein the payment-specific authentication information included in the pre-authorization release message or the pre-authorization cancellation message is signed by the merchant.

21. A method for performing refund of a payment from a customer to a merchant with a cash card, the cash card associated with a predetermined amount of money and usable in purchase over a first network, the method comprising:
creating payment-specific authentication information at a time of the payment;
transferring an amount of the payment from a first account associated with the cash card of the customer to a second account of the merchant according to the payment-specific authentication information;
receiving a refund message including the payment-specific authentication information with a signature of the merchant; and
returning at least a part of the amount transferred from the second account to the first account according to the refund request when the signature is verified.

22. A method for escrowing transaction between a seller and a buyer with a cash card, the cash card associated with a predetermined amount of money and usable in purchase over a first network, the method comprising:
creating payment-specific authentication information when the buyer purchases an item from the seller;
subtracting a cost of the item from a first account associated with the cash card of the buyer according to the payment-specific authentication information;
transmitting the payment-specific authentication information such that the seller receives the payment-specific authentication information after the buyer receives the item; and
adding at least a part of the cost subtracted from the first account to a second account of the seller when the payment-specific authentication information from the seller.

23. The method of claim 22, further comprising:
creating payment-specific verification information when the buyer purchases the item from the seller; and
transmitting the payment-specific verification information such that the seller sends the item after the seller receives the payment-specific verification information.

24. The method of claim 22, further comprising:
adding at least a part of the cost subtracted from the first account to the first account when the payment-specific authentication information is not received from the seller or a proper refund request is received from the buyer.

25. The method of claim 22, wherein at least one of identities of the buyer and the seller is not required in escrowing.
